(19) United States
(12) Patent Application Publication
(10) Pub. No.: US 2026/0108963 A1
(43) Pub. Date: Apr. 23, 2026

(54) SUSCEPTOR AND METHOD OF MANUFACTURING SAME

(71) Applicant: MiCo Ceramics Ltd., Anseong-si (KR)

(72) Inventors: So Young Park, Anseong-si (KR); Byung Gil Chun, Anseong-si (KR); Kyu Ra Lee, Anseong-si (KR); Dae Seong Kang, Anseong-si (KR)

(21) Appl. No.: 19/359,743

(22) Filed: Oct. 16, 2025

(30) Foreign Application Priority Data
Oct. 18, 2024 (KR) 10-2024-0142792

(51) Int. Cl. B23K 1/00; B23K 101/38; B23K 103/10; H05B 6/10

(52) U.S. Cl. CPC B23K 1/0008; H05B 6/105; B23K 2101/38; B23K 2103/10

(57) ABSTRACT

Provided are a susceptor and a method of manufacturing the same. In a method of manufacturing a base body of the susceptor, the base body includes a lower plate and an upper plate made of respective materials, and a bonding portion therebetween. The method may include: sequentially laminating a first active metal layer and a first aluminum layer on a bonding surface of the upper plate; sequentially laminating a second active metal layer and a second aluminum layer on a bonding surface of the lower plate; and interposing a brazing filler layer between the first aluminum layer of the upper plate and the second aluminum layer of the lower plate, and converting the brazing filler layer, the first aluminum layer, and the second aluminum layer into a brazing layer through heat treatment to braze the lower plate and the upper plate.

### CROSS-REFERENCE TO RELATED APPLICATION(S)

This application is based on and claims priority under 35 U.S.C. 119 to Korean Patent Application No. 10-2024-0142792, filed on Oct. 18, 2024, in the Korean Intellectual Property Office, the disclosure of which is herein incorporated by reference in its entirety.

### BACKGROUND OF THE INVENTION

### 1. Field of the Invention

The present disclosure relates to a ceramic susceptor, and more particularly, to brazing for improving the bonding strength between an upper plate and a lower plate of a base body made of a metal matrix composite (MMC) material.

### 2. Description of the Prior Art

In general, a semiconductor device or a display device is manufactured through a semiconductor process of sequentially laminating multiple thin film layers including a dielectric layer and a metal layer on a glass substrate, a flexible substrate, or a semiconductor wafer substrate and then patterning the thin film layers. In such a semiconductor process apparatus, a susceptor such as an electrostatic chuck or a ceramic heater is provided to support a glass substrate, a flexible substrate, a semiconductor wafer substrate, or the like and to perform a semiconductor process. An electrostatic chuck is mainly used in a process of dry-etching thin film layers formed on a substrate.

FIGS. 1A and 1B are views illustrating problems of conventional ceramic susceptors. FIG. 1A illustrates bonding of an upper plate and a lower plate of an Al-based base body by a brazing filler, and FIG. 1B illustrates bonding of an upper plate and a lower plate of a base body made of a metal matrix composite (MMC) material using a brazing filler.

As illustrated in FIG. 1A, the upper and lower plates of the Al-based base body of a conventional ceramic susceptor may be bonded through a general aluminum brazing method. In this case, since the base body and the brazing filler are made of the same series material, good brazing may be achieved.

Recently, with the introduction of extreme processes, in order to particularly compensate for low-temperature deformation, an MMC material, in which metal and ceramic powders are composited, has been applied to a base body of a ceramic susceptor. However, as illustrated in FIG. 1B, in the case of a base body made of an MMC material of a conventional ceramic susceptor, when upper and lower plates are bonded using a general aluminum brazing method, since the brazing filler positioned between MMC materials is made of a material different from the MMC materials, bonding defects occur, resulting in problems such as leakage of process gases including He gas during a process in a semiconductor apparatus, leakage of a coolant in a cooling channel, and poor degree of vacuum, which cause process defects or yield reduction.

### SUMMARY OF THE INVENTION

The present disclosure has been made to solve the above-mentioned problems, and the present disclosure provides a method of manufacturing a base body of a ceramic susceptor in which a multilayer (active metal layer and aluminum layer) surface treatment is applied between a base body made of a metal matric composite (MMC) material and a brazing filler in order to improve the bonding strength between the upper plate and the lower plate of the base made of the MMC material, and to provide a ceramic susceptor to which the base body is applied.

First, to summarize features of the present disclosure, in view of the foregoing, an aspect of the present disclosure provides a method of manufacturing a base body of a susceptor, in which the base body includes a lower plate and an upper plate made of respective materials, and a bonding portion therebetween. The method may include: sequentially laminating a first active metal layer and a first aluminum layer on a bonding surface of the upper plate; sequentially laminating a second active metal layer and a second aluminum layer on a bonding surface of the lower plate; and interposing a brazing filler layer between the first aluminum layer of the upper plate and the second aluminum layer of the lower plate, and converting the brazing filler layer, the first aluminum layer, and the second aluminum layer into a brazing layer through heat treatment to braze the lower plate and the upper plate.

The lower plate may include a groove between bonding surfaces.

The first active metal layer and the second active metal layer may each include at least one of Ti, Zr, Nb, Hf, and Ta.

The first active metal layer and the second active metal layer may each have a thickness of 1 to 5 μm.

The first aluminum layer and the second aluminum layer may each have a thickness of 5 to 10 μm.

In the brazing layer, a proportion of Al crystal grains having a diameter of greater than 0 μm and less than 6 μm may be larger than a proportion of Al crystal grains having a diameter of 6 μm or more and less than 60 μm.

Al crystal grains having a diameter of greater than 0 μm and less than 6 μm in the brazing layer may be distributed more in a boundary region of the brazing layer with the first active metal layer and the second active metal layer than in a central region of the brazing layer.

Al crystal grains in a central region of the brazing layer may have a diameter of 6 μm or more and less than 60 μm, and Al crystal grains in a boundary region of the brazing layer with the first aluminum layer of the upper plate or the second aluminum layer of the lower plate may have a diameter of greater than 0.0 μm and less than 6 μm.

According to another aspect of the present disclosure, a susceptor includes a base body and an insulating plate, in which the base body includes a lower plate and an upper plate made of respective materials, and a bonding portion therebetween. The bonding portion may include a first active metal layer on the upper plate side, a second active metal layer on the lower plate side, and a brazing layer between the first active metal layer and the second active metal layer. The brazing layer may be formed by inserting a brazing filler layer between a first aluminum layer on the first active metal layer of the upper plate and a second aluminum layer on the second active metal layer of the lower plate, which are formed prior to brazing, and then converting the brazing filler layer, the first aluminum layer, and the second aluminum layer through heat treatment.

According to a susceptor and a method of manufacturing the same of the present disclosure, by applying multilayer (an active metal layer and an aluminum layer) surface treatment between each plate (an upper plate and a lower plate) of a base body and a brazing filler, the bonding strength between the upper plate and the lower plate of a base body made of an MMC material can be improved. As a result, in an electrostatic chuck body within a semiconductor apparatus, the leak rate of process gases such as He gas can be reduced, the degree of vacuum can be improved, and leakage of coolant from a cooling channel can be reduced.

Therefore, stable processes can be maintained, contributing to yield improvement. In the examples, it was confirmed that the He gas leak rate was lowered from the previous 1.0E-03 (mbar*l/s) to the level of 2.0.E08 (mbar*l/s) after improvement.

### BRIEF DESCRIPTION OF THE DRAWINGS

The accompanying drawings, which are included as part of a detailed description to aid the understanding of the present disclosure, provide embodiments of the present disclosure, and, together with the detailed description, illustrate the technical idea of the present disclosure, in which:

FIGS. 1A and 1B are views illustrating problems of conventional susceptors;

FIGS. 2A to 2C are cross-sectional views of a lower plate and an upper plate constituting a base body illustrating a method of manufacturing a susceptor according to an embodiment of the present disclosure;

FIG. 3 is a view illustrating a structure of bonding an insulating plate to the base body of the susceptor according to an embodiment of the present disclosure;

FIG. 4 is a view illustrating an example of a photograph of an actually manufactured lower plate for the base body of the susceptor according to an embodiment of the present disclosure;

FIG. 5 is a view illustrating an example of a photograph captured from above an actually manufactured upper plate of the base body of the susceptor according to an embodiment of the present disclosure;

FIG. 6 is an example of an SEM image of a cross section of a bonding portion formed in a base body of a susceptor according to an embodiment of the present disclosure; and

FIGS. 7A to 7F illustrate SEM images of Al crystal grains in brazing layers and distribution graphs of the Al crystal grains according to grain size for each of Embodiments 1 to 6 in Table 3.

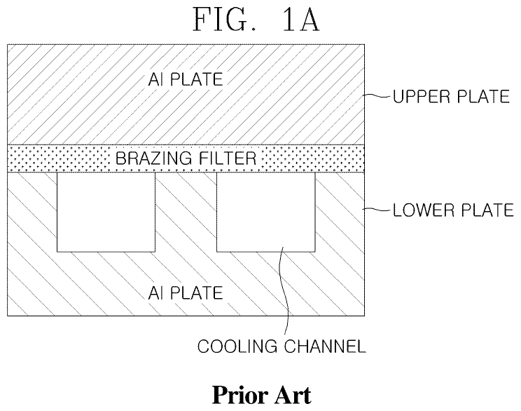

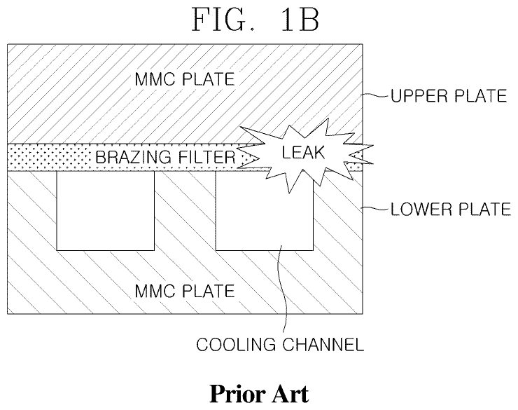

### DETAILED DESCRIPTION OF THE EXEMPLARY EMBODIMENTS

Hereinafter, the present disclosure will be described in detail with reference to the accompanying drawings. Herein, like components in each drawing are denoted by like reference numerals if possible. In addition, detailed descriptions of already known functions and/or configurations will be omitted. In the following description, components necessary for understanding operations according to various embodiments will be mainly described, and descriptions of elements that may obscure the gist of the description will be omitted. In addition, some elements in the drawings may be exaggerated, omitted, or schematically illustrated. The size of each component does not entirely reflect the actual size. Therefore, the descriptions provided herein are not limited by the relative sizes or spacings of the components drawn in each drawing.

In describing the embodiments of the present disclosure, when a detailed description of the known technology related to the present disclosure is determined to unnecessarily obscure the subject matter of the present disclosure, the detailed description will be omitted. In addition, terms to be described later are defined in consideration of functions in the present disclosure, and may vary according to the intention, custom, or the like of a user or operator. Therefore, the definitions of the terms should be made based on the description throughout this specification. Terms used in the detailed description are only for describing the embodiments of the present disclosure and should not be construed as limiting in any way. Unless expressly used otherwise, singular expressions include the meanings of plural expressions. As used herein, expressions such as “including” or “comprising” are intended to indicate any features, numbers, steps, operations, elements, or some or combinations thereof, and should not be construed to exclude the existence or possibility of one or more other features, numbers, steps, operations, elements, or some or combinations thereof, in addition to those described above.

In addition, terms such as “first” and “second” may be used to describe various components, but the components are not limited by the terms, and these terms are only used for the purpose of distinguishing one component from another.

First, in the present disclosure, a (ceramic) susceptor may serve as a semiconductor device for processing various types of processing target substrates such as a semiconductor wafer, a glass substrate, and a flexible substrate, and may include an electrode (or conductor) such as an electrostatic chuck electrode to be used as an electrostatic chuck configured to support the processing target substrate. In some cases, the susceptor may further include a heater (or heating wire) pattern configured to heat the processing target substrate to a predetermined temperature, or an electrode (or a conductor) such as a high-frequency electrode for processing the processing target substrate, for example, plasma-enhanced chemical vapor deposition. Therefore, the electrode (or conductor) referred to hereinafter will be described by taking an electrostatic chuck electrode as an example, but is not limited thereto, and in some cases, the electrostatic chuck electrode may be used as a heater (or heating wire) pattern.

For example, the electrostatic chuck electrode or the high-frequency electrode may be made of a conductive metal material such as silver (Ag), gold (Au), nickel (Ni), tungsten (W), molybdenum (Mo), or titanium (Ti), or an alloy thereof. In a semiconductor manufacturing process, the electrostatic chuck electrode may receive a power bias to generate electrostatic force, thereby performing chucking of a substrate placed on the upper surface of the susceptor. When unloading the substrate, the electrostatic chuck electrode may receive an opposite bias to be discharged, thereby performing dechucking of the substrate. In a semiconductor manufacturing process, the high-frequency electrode may receive power to enable processing, such as plasma-enhanced chemical vapor deposition or dry etching, on the substrate located on the upper surface of the susceptor. In addition, for example, a heater (or heating wire) provided in the susceptor may be formed in a plate-shaped coil form or a flat plate form by a resistance wire having a predetermined resistance. The heater (or heating wire) may be formed in a multilayer structure for precise temperature control. Such a heater (or heating wire) may receive power and perform a function of heating a substrate positioned on an upper surface of the susceptor to a predetermined temperature for performing a predetermined semiconductor manufacturing process.

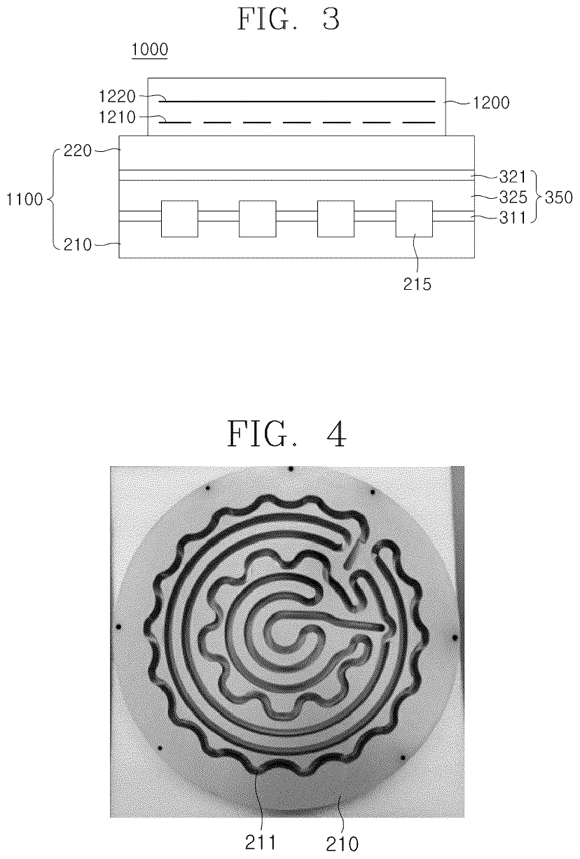

A susceptor 1000 of the present disclosure includes a base body (1100 in FIG. 3) including a lower plate (210 in FIG. 3) and an upper plate (220 in FIG. 3) bonded to each other, an insulating plate (1200 in FIG. 3) bonded onto the base body, and conductors (or electrodes) 1210 and 1220 described above are disposed/buried in the insulating plate (1200 in FIG. 3).

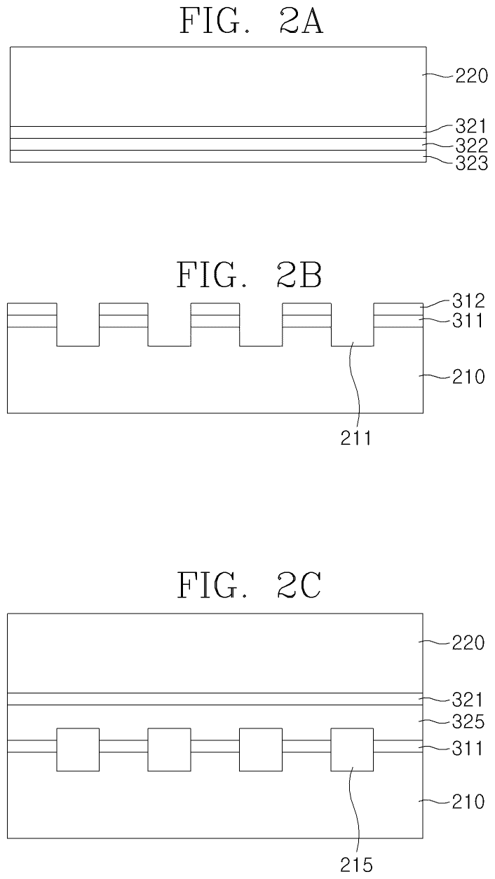

Hereinafter, with reference to FIGS. 2A to 2C, a method of manufacturing the susceptor 1000 according to an embodiment of the present disclosure and the structure of the susceptor 1000 manufactured thereby will be described in detail.

FIGS. 2A to 2C are cross-sectional views of the lower plate and the upper plate constituting the base body illustrating a method of manufacturing the susceptor 1000 according to an embodiment of the present disclosure.

First, referring to FIG. 2A, in order to manufacture the susceptor 1000 according to an embodiment of the present disclosure, a first active metal layer 321 and a first aluminum layer 322 are sequentially laminated on a bonding surface of the upper plate 220, that is, one surface of the upper plate 220. As described below, a brazing filler layer 323 is interposed between the first aluminum layer 322 and a second aluminum layer 312.

In addition, referring to FIG. 2B, a second active metal layer 311 and a second aluminum layer 312 are sequentially laminated on a bonding surface of the lower plate 210 of the substrate other than a groove 211 (see FIG. 4), which will serve as a cooling channel (215 in FIG. 3) of the lower plate 210.

In addition, referring to FIG. 2C, by interposing the brazing filler layer 323 between the first aluminum layer 322 and the second aluminum layer 312 and brazing the lower plate 210 and the upper plate 220 together, a base body 1100 of the susceptor 1000 of the present disclosure, which is formed as a bonded body of the lower plate 210 and the upper plate 220, is manufactured.

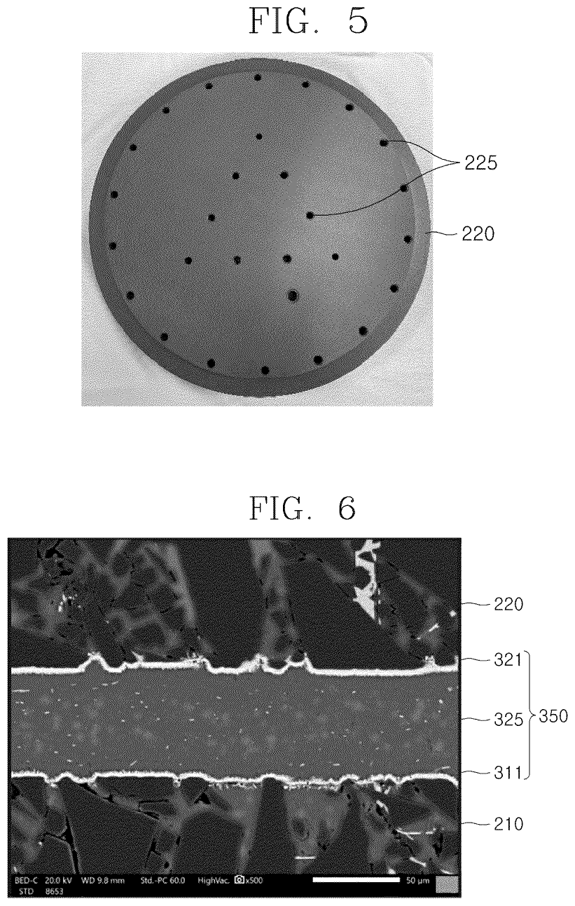

For the brazing, the brazing filler layer 323 may be interposed between the first aluminum layer 322 and the second aluminum layer 312, and then the lower plate 210 and the upper plate 220 may be brought into close contact with each other, followed by heat treatment through high-temperature heating and cooling, thereby allowing a conductive filler of the brazing filler layer 323 to bond the lower plate 210 and the upper plate 220. As the conductive filler of the brazing filler layer 323, an Al—Si metal filler, for example, an Au—Ni metal filler, or an Al-based metal filler may be used. One side of the upper plate 220 is bonded to the lower plate 210, and as illustrated in FIG. 5, holes 225 corresponding to holes in the insulating plate (1200 in FIG. 3) are provided on other side of the upper plate 220 to be connected to a channel for providing cooling gas or the like, and may be configured to provide cooling gas over the insulating plate (1200 in FIG. 3) as needed.

The above-described lower plate 210 and upper plate 220 are made of a material, specifically an MMC material of Al-ceramic composite powder, in order to prevent deformation, particularly low-temperature deformation, due to changes in the extreme process environment. For example, the lower plate 210 and the upper plate 220 may be made of a powder of, for example, a composite of Al with SiC, Si, boron (B), alumina (Al₂O₃), graphite, and the like.

In addition, the first active metal layer 321 of the upper plate 220 and the second active metal layer 311 of the lower plate 210 may include one of Ti, Zr, Nb, Hf, and Ta, or an alloy thereof, and may have a thickness of 1 to 5 μm.

In addition, the first aluminum layer 322 of the upper plate 220 and the second aluminum layer 312 of the lower plate 210 may have a thickness of 5 to 10 μm.

The first active metal layer 321 of the upper plate 220 and the second active metal layer 311 of the lower plate 210 may improve bonding properties by being melted together with the conductive filler, the first aluminum layer 322, and the second aluminum layer 312 during the brazing. That is, the first active metal layer 321 of the upper plate 220 and the second active metal layer 311 of the lower plate 210 may cause a redox reaction at an interface having different physical and chemical properties so as to improve bonding properties on both sides, thereby forming an interfacial product (see “Bonding of Ceramics and Metals Using Active Metal Brazing,” Journal of the Microelectronics & Packaging Society, Vol. 18, No. 3, pp. 1-7, 2011). Accordingly, during brazing, the brazing filler layer 323, the first aluminum layer 322, and the second aluminum layer 312 are converted into a brazing layer 325 through heat treatment, so that the lower plate 210 and the upper plate 220 are brazed together firmly and stably.

When the base body 1100 is obtained through the method of manufacturing the susceptor 1000 according to an embodiment of the present disclosure as described above, the susceptor 1000 according to an embodiment of the present disclosure may be manufactured by bonding the insulating plate 1200 thereto.

FIG. 3 is a view illustrating a structure of bonding the insulating plate 1200 to the base body 1100 of the susceptor 1000 according to an embodiment of the present disclosure.

Referring to FIG. 3, the susceptor 1000 according to an embodiment of the present disclosure includes the base body 1100 including the lower plate 210 and the upper plate 220, and the insulating plate 1200 bonded thereon.

Conductors (or electrodes) 1210 and 1220 are disposed/buried in the above-described insulating plate 1200. As described above, the susceptor 1000 is a semiconductor device for processing various processing target substrates such as a semiconductor wafer, a glass substrate, or a flexible substrate. The conductors (or electrodes) 1210 and 1220 include an electrostatic chuck electrode to be used as an electrostatic chuck for supporting the processing target substrate, and, in some cases, may further include a heater (or heating wire) for heating the processing target substrate to a predetermined temperature, and/or a high-frequency electrode for processing the processing target substrate, such as plasma-enhanced chemical vapor deposition or dry etching.

The base body 1100 includes a cooling channel 215 formed in the groove 211 through brazing of the lower plate 210 and the upper plate 220 with the brazing filler layer 323. The cooling channel 215 is a channel for circulation of a coolant, for example, cooling water or cooling oil, and the coolant may circulate through the cooling channel 215 to maintain the temperature of the susceptor 1000 at a predetermined level during a semiconductor process.

Meanwhile, a bonding portion 350 between the lower plate 210 and the upper plate 220 is formed between the cooling channels 215. The bonding portion 350 between the lower plate 210 and the upper plate 220, that is, on an upper surface of the lower plate 210 substrate other than the groove 211, includes a first active metal layer 321 laminated on the upper plate 220, a second active metal layer 311 laminated on the lower plate 210, and a brazing layer 325 between the first active metal layer 321 and the second active metal layer 311. The brazing layer 325 is a layer formed by converting the brazing filler layer 323, the first aluminum layer 322, and the second aluminum layer 312, through heat treatment after inserting the brazing filler layer 323 between the first aluminum layer 322 on the first active metal layer 321 of the upper plate 220 and the second aluminum layer 312 on the second active metal layer 311 of the lower plate 210 (as formed before brazing, see FIGS. 2A and 2B).

### Embodiment 1

Table 1 below shows results obtained regarding leakage of He gas and cooling water for manufactured base bodies 1100 depending on whether or not active metal layers 311 and 321 and aluminum (Al) layers 312 and 322 were applied (applied: ◯, not applied: X) as surface treatment conditions of the bonding portions 350 when the lower plate 210 and the upper plate 220 made of an MMC material were used and an Al-based metal filler was applied to the brazing filler layers 323.

TABLE 1

| | | | Surface treatment | | Examination result (He gas leakage | | |
|---|---|---|---|---|---|---|---|
| | | | condition | | standard: 1.0E−04 (mbar*l/s) or more) | | |
| | | | Active | | He gas | Coolant | |
| | Common condition | | metal | Al | leakage | leakage | Bonding |
| Type | Material | Filler | layer | layer | (mbar*l/s) | (Yes/No) | result |
| 1 | MMC | Al-based | X | X | | ◯ | Poor |
| 2 | MMC | Al-based | ◯ | X | | ◯ | Poor |
| 3 | MMC | Al-based | ◯ | ◯ | | X | Excellent |

As shown in Table 1 above, in the case where the active metal layers 311 and 321 and aluminum (Al) layers 312 and 322 were not applied, and the case where the active metal layers 311 and 321 were applied but the aluminum (Al) layers 312 and 322 were not applied, defects of coolant leakage and He gas leakage from the bonding portions at a level equal to or higher than the He gas leakage standard of 1.0E-04 (mbar*l/s) were confirmed. However, when the lower plate 210 and the upper plate 220 made of an MMC material were used and, as the surface treatment conditions of the bonding portion 350, both the active metal layers 311 and 321 and the aluminum (Al) layers 312 and 322 were applied for brazing, as in the present disclosure, it was confirmed that the bonding of the bonding portion 350 was excellent, with no leakage of cooling water and He gas leakage improved to a negligible level of less than the He gas leakage standard of 1.0E-04 (mbar*l/s).

Table 2 below shows results of a comparison of defect rates of base bodies 1100 manufactured depending on whether or not active metal layers 311 and 321 and aluminum (Al) layers 312 and 322 were applied (applied: ◯, not applied: X) as surface treatment conditions of a bonding portion 350, when the lower plate 210 and the upper plate 220 made of an MMC material were used and an Al-based metal filler was applied to a brazing filler layer 323.

TABLE 2

| | Common condition | | Manufacturing result | | | | |
|---|---|---|---|---|---|---|---|
| | Active | Al | Total | Excellent | Defective | Defect | Average defect |
| Type | metal layer | layer | quantity | quantity | Quantity | rate(%) | rate(%) |
| 1 | X | X | 6 | 2 | 4 | 67 | 77 |
| 2 | ◯ | X | 7 | 1 | 6 | 86 | |
| 3 | ◯ | ◯ | 6 | 6 | 0 | 0 | 0 |

As shown in Table 2 above, in the case where the active metal layers 311 and 321 and aluminum (Al) layers 312 and 322 were not applied, and the case where the active metal layers 311 and 321 were applied but the aluminum (Al) layers 312 and 322 were not applied, the defect rate for coolant leakage and He gas leakage from the bonding portions at a level equal to or higher than the He gas leakage standard of 1.0E-04 (mbar*l/s) was 77% on average.

However, when the lower plate 210 and the upper plate 220 made of an MMC material were used and, as the surface treatment conditions of the bonding portion 350, both the active metal layers 311 and 321 and the aluminum (Al) layers 312 and 322 were applied for brazing, as in the present disclosure, the bonding of the bonding portion 350 was excellent, and the defect rate was zero.

### Embodiment 2

FIG. 6 is an example of a scanning electron microscope (SEM) image of a cross section of a bonding portion 350 formed in a base body 1100 of a susceptor 1000 according to an embodiment of the present disclosure.

Referring to FIG. 6, in the SEM image (magnification ×2000) of the cross section of the bonding portion 350, it can be confirmed that the bonding portion 350, including a first active metal layer 321, a second active metal layer 311, and a brazing layer 325, brazes the lower plate 210 and the upper plate 220 made of an MMC material firmly and stably.

Here, the brazing was performed by forming an Al—Si metal filler as the brazing filler layer 323 with a thickness of 48 to 51 μm. In the cross section of the bonding portion 350, particularly the brazing layer 325, the diameter size of the Al crystal grains was observed to be about 0 to 60 μm. In particular, the proportion of the number of Al crystal grains having a diameter size of 0 to 6 μm was high, at 51 to 92%, while the proportion of the number of Al crystal grains having a diameter size of 6 to 60 μm was lower, at 8 to 42%. This indicates that the brazing layer 325 of the bonding portion 350 brazes the lower plate 210 and the upper plate 220 firmly and stably.

### ADDITIONAL EMBODIMENTS AND COMPARATIVE EXAMPLES

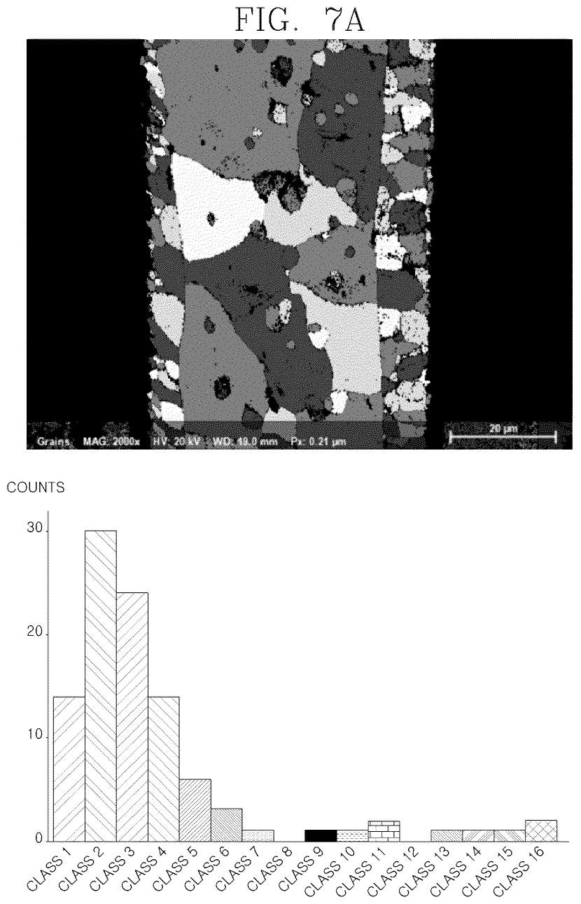

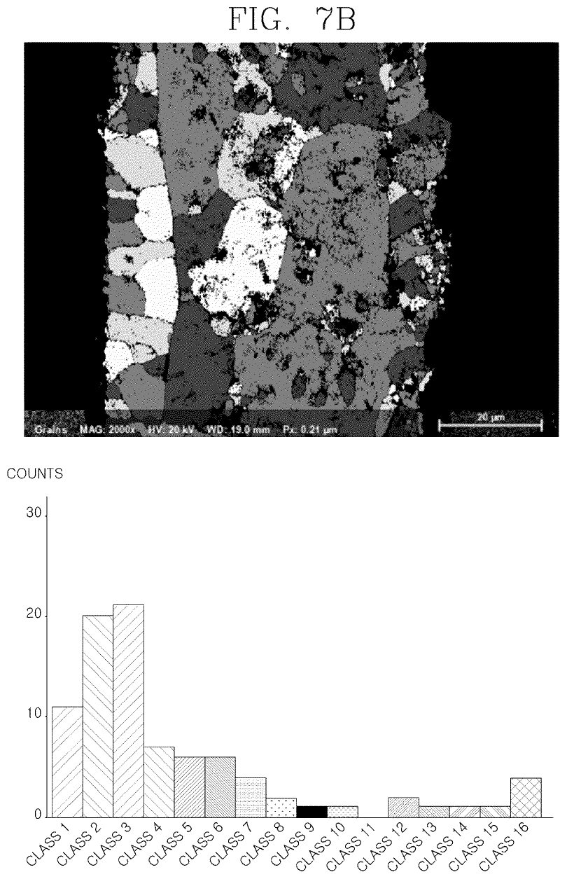

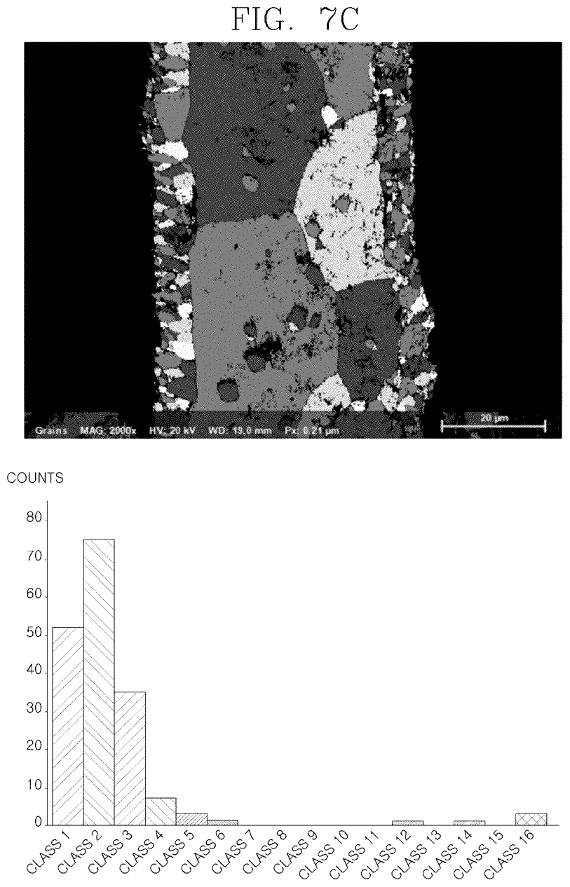

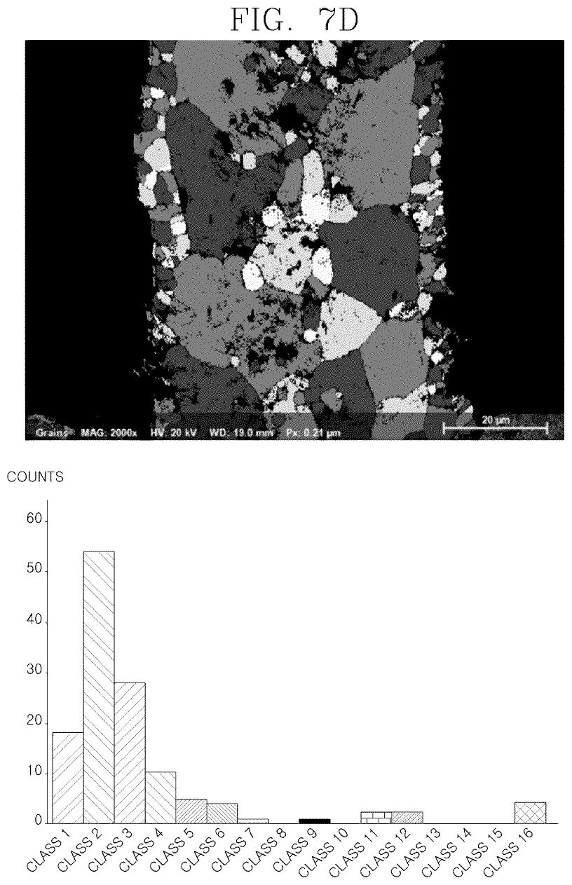

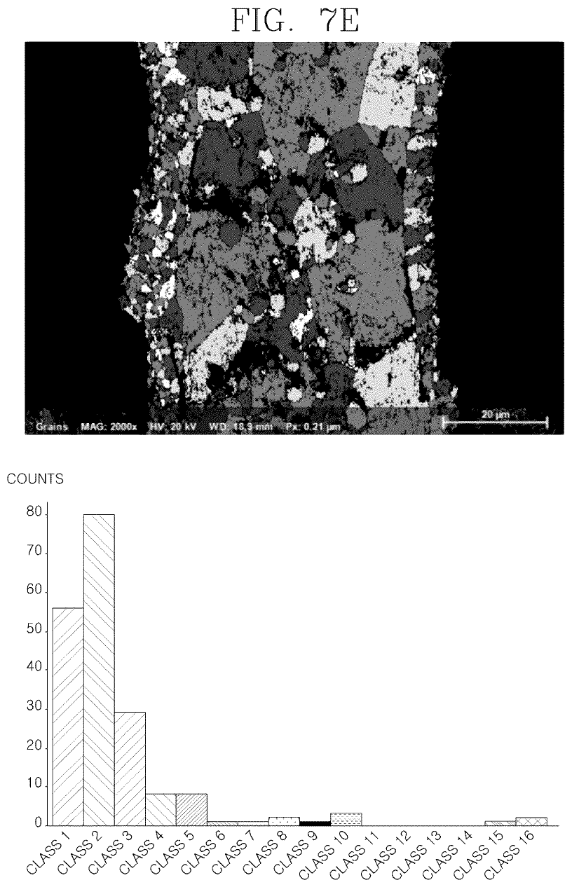

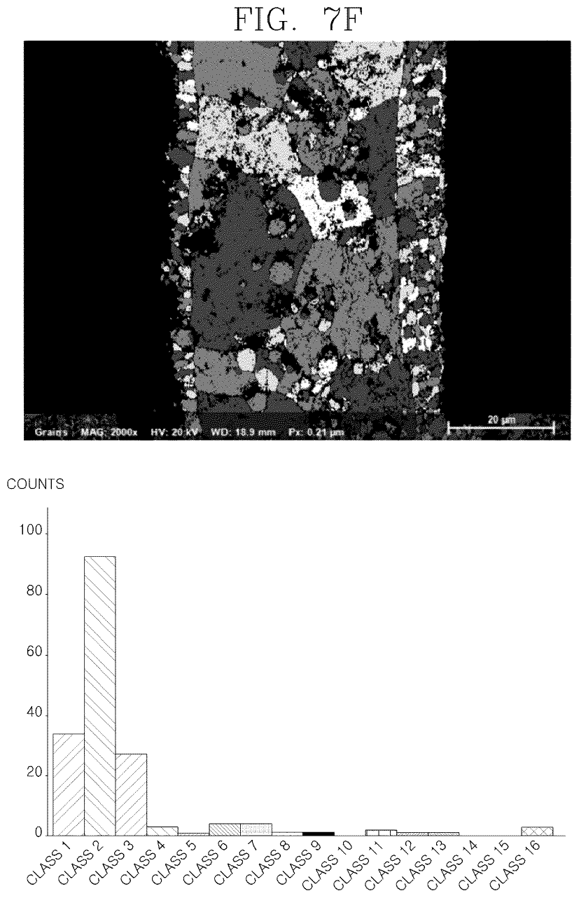

Table 3 below shows thicknesses of the aluminum (Al) layers 312 and 322 of respective embodiments (2 to 8 μm) and comparative examples (0.5 to 5 μm) when each base body 1100 of a susceptor 1000 was manufactured using a lower plate 210 and an upper plate 220 made of an MMC material, and the thicknesses (5 to 35 μm) of the brazing filler layers 323 applied thereto. In particular, for respective Embodiments 1 to 6 in Table 3, FIGS. 7A to 7F each show an SEM image (upper image) of Al crystal grains in a brazing layer 325 of a bonding portion 350 of a base body 1100, and a distribution graph (lower bar graph) of the Al crystal grains according to grain size. In FIGS. 7A to 7F, each SEM image (upper image) shows Al crystal grains between the upper plate 220 on the left side and the lower plate 210 on the right side, and each distribution graph of the Al crystal grains according to grain size (lower bar graph) indicates the number of Al crystal grains for each grain size. The class-based grain sizes of the Al crystal grains in the drawings can be referred to in Table 4.

TABLE 3

| | Thickness of | Thickness of brazing |
|---|---|---|
| | Al layer | filler layer |
| No. | (μm) | (μm) |
| Embodiment 1 | 5 | 35 |
| Embodiment 2 | 8 | 35 |
| Embodiment 3 | 6 | 35 |
| Embodiment 4 | 4 | 35 |
| Embodiment 5 | 3 | 35 |
| Embodiment 6 | 2 | 35 |
| Comparative Example 1 | 2 | 35 |
| Comparative Example 2 | 0.5 | 35 |
| Comparative Example 3 | 5 | 10 |
| Comparative Example 4 | 5 | 5 |

TABLE 4

Grain size (μm)

| Classification | Min. | Max. |
|---|---|---|
| Class 1 | 0 | 2 |
| Class 2 | 2 | 4 |
| Class 3 | 4 | 6 |
| Class 4 | 6 | 8 |
| Class 5 | 8 | 10 |
| Class 6 | 10 | 12 |
| Class 7 | 12 | 14 |
| Class 8 | 14 | 16 |
| Class 9 | 16 | 18 |
| Class 10 | 18 | 20 |
| Class 11 | 20 | 22 |
| Class 12 | 22 | 24 |
| Class 13 | 24 | 26 |
| Class 14 | 26 | 28 |
| Class 15 | 28 | 30 |
| Class 16 | >30 | — |

The results of manufacturing such as the size of Al crystal grains in the brazing layer 325 of the bonding portion 350 of each base body 1100 manufactured under the above conditions, the degree of adhesion between the lower plate 210 and the upper plate 220, and the presence or absence of defects, are summarized in Table 5 below.

TABLE 5

| | Proportion of Al | | | |
|---|---|---|---|---|
| | grain size counts | | | |
| | 0 to 6 μm | 6 to 60 μm | | |
| | (%) | (%) | Adhesion | Defect |
| Embodiment 1 | 67.3 | 32.7 | Excellent | Absent |
| Embodiment 2 | 59.1 | 40.9 | Excellent | Absent |
| Embodiment 3 | 91.0 | 9.0 | Excellent | Absent |
| Embodiment 4 | 77.5 | 22.5 | Excellent | Absent |
| Embodiment 5 | 85.9 | 14.1 | Excellent | Absent |
| Embodiment 6 | 87.9 | 12.1 | Excellent | Absent |
| Comparative Example 1 | 45 | 55 | Good | Absent |
| Comparative Example 2 | 50 | 50 | Good | Absent |
| Comparative Example 3 | 95 | 5 | Poor | Present |
| Comparative Example 4 | 100 | 0 | Poor | Present |

As shown in Tables 3 and 5 above, in Comparative Examples 1 and 2, it was confirmed that the proportion of the number of Al crystal grains having a diameter of 0 to 6 μm and the proportion of the number of Al crystal grains having a diameter of 6 to 60 μm showed similar values without significant difference, and in such cases where the Al layer had a small thickness, it was confirmed that although some bonding occurred, defects (e.g., cracks, voids, open pores, and unbonded regions) were detected. In addition, in Comparative Examples 3 and 4, it was confirmed that the proportion of the number of Al crystal grains having a diameter of 6 to 60 μm was significantly lower than the proportion of the number of Al crystal grains having a diameter of 0 to 6 μm, and in such cases where the brazing filler layer 323 was 5% or less, bonding did not occur. In contrast, in Embodiments 1 to 6 of the present disclosure, it was confirmed that excellent adhesion was exhibited and no defects were detected, and that the proportion of the number of Al crystal grains having a diameter of 0 to 6 μm was high, at 51 to 92%, while the proportion of the number of Al crystal grains having a diameter of 6 to 60 μm was lower, at 8 to 42%. Accordingly, it was confirmed that the embodiments of the present disclosure can provide an optimal base body 1100.

In particular, in the brazing layer 325 of the bonding portion 350 of each base body 1100 of the present disclosure, excellent bonding performance was exhibited when the proportion of Al crystal grains having a diameter greater than 0 μm and less than 6 μm was larger than the proportion of Al crystal grains having a diameter of 6 μm or more and less than 60 μm. In this case, the diameter of the Al crystal grains in the central region (the central region between the upper plate and the lower plate) of the brazing layer 325 was 6 μm or more and less than 35 μm, and the diameter of the Al crystal grains in the boundary region of the brazing layer 325 between the first active metal layer 321 of the upper plate 220 and the second active metal layer 311 of the lower plate 210 was greater than 0.0 μm and less than 6 μm. In addition, the Al crystal grains having a diameter of 0 to 6 μm were distributed more in the boundary region than in the central region.

According to a susceptor 1000 and a method of manufacturing the same of the present disclosure, by applying multilayer (active metal layer and aluminum layer) surface treatment between each plate (upper plate 220 and lower plate 210) of the base body and the brazing filler, the bonding strength between the upper plate 220 and the lower plate 210 of the MMC base body 1100 can be improved. As a result, during a process in a semiconductor apparatus, the leak rate of process gases such as He gas can be reduced, the degree of vacuum can be improved, and leakage of coolant from a cooling channel can be reduced. Therefore, stable processes can be maintained, contributing to yield improvement. In the examples, it was confirmed that the He gas leak rate was lowered from the previous 1.0E-03 (mbar*l/s) to the level of 2.0E-08 (mbar*l/s) after improvement.

In the foregoing, the present disclosure has been described based on specific details, such as concrete components, limited embodiments, and drawings, but these have been provided merely to aid a more comprehensive understanding of the present disclosure, and the present disclosure is not limited to the above-described embodiments. Various modifications and alterations may be made without departing from the essential characteristics of the present disclosure by a person ordinarily skilled in the art to which the present disclosure pertains. Therefore, the spirit of the present disclosure should not be limited to the described embodiments, and not only the appended claims, but also all technical ideas that are equivalent or have equivalent modifications to the claims should be construed as being included within the scope of the present disclosure.

What is claimed is:

1. A method of manufacturing a base body of a susceptor that comprises a lower plate and an upper plate made of respective MMC materials, and a bonding portion therebetween, the method comprising:
sequentially laminating a first active metal layer and a first aluminum layer on a bonding surface of the upper plate;
sequentially laminating a second active metal layer and a second aluminum layer on a bonding surface of the lower plate; and
interposing a brazing filler layer between the first aluminum layer of the upper plate and the second aluminum layer of the lower plate, and converting the brazing filler layer, the first aluminum layer, and the second aluminum layer into a brazing layer through heat treatment to braze the lower plate and the upper plate.

2. The method of claim 1, wherein the lower plate comprises a groove between bonding surfaces.

3. The method of claim 1, wherein the first active metal layer and the second active metal layer each comprises at least one of Ti, Zr, Nb, Hf, and Ta.

4. The method of claim 1, wherein the first active metal layer and the second active metal layer each have a thickness of 1 to 5 μm.

5. The method of claim 1, wherein the first aluminum layer and the second aluminum layer each have a thickness of 5 to 10 μm.

6. The method of claim 1, wherein, in the brazing layer, a proportion of Al crystal grains having a diameter of greater than 0 μm and less than 6 μm is larger than a proportion of Al crystal grains having a diameter of 6 μm or more and less than 60 μm.

7. The method of claim 1, wherein Al crystal grains having a diameter of greater than 0 μm and less than 6 μm in the brazing layer are distributed more in a boundary region of the brazing layer with the first active metal layer and the second active metal layer than in a central region of the brazing layer.

8. The method of claim 1, wherein Al crystal grains in a central region of the brazing layer have a diameter of 6 μm or more and less than 60 μm, and
wherein Al crystal grains in a boundary region with the first aluminum layer of the upper plate or the second aluminum layer of the lower plate have a diameter of greater than 0.0 μm and less than 6 μm.

9. A susceptor comprising:
a base body; and
an insulating plate,
wherein the base body comprises:
a lower plate and an upper plate made of respective MMC materials; and
a bonding portion therebetween,
wherein the bonding portion comprises:
a first active metal layer on the upper plate side;
a second active metal layer on the lower plate side; and
a brazing layer between the first active metal layer and the second active metal layer,
wherein the brazing layer is a bonding layer formed by converting a first aluminum layer on the first active metal layer, a second aluminum layer on the second active metal layer and a brazing filler layer interposed between the first aluminum layer and the second aluminum layer, through heat treatment, and
wherein in the brazing layer, a proportion of Al crystal grains having a diameter of greater than 0 μm and less than 6 μm is larger than a proportion of Al crystal grains having a diameter of 6 μm or more and less than 60 μm.

10. The susceptor of claim 9, wherein the bonding portion is formed between cooling channels of the base body.

11. The susceptor of claim 9, wherein the first active metal layer and the second active metal layer each comprise at least one of Ti, Zr, Nb, Hf, and Ta.

12. The susceptor of claim 9, wherein the first active metal layer and the second active metal layer each have a thickness of 1 to 5 μm.

13. The susceptor of claim 9, wherein the first aluminum layer and the second aluminum layer each have a thickness of 5 to 10 μm.

14. The susceptor of claim 9, wherein Al crystal grains having a diameter of greater than 0 μm and less than 6 μm in the brazing layer are distributed more in a boundary region of the brazing layer with the first active metal layer and the second active metal layer than in a central region of the brazing layer.

15. The susceptor of claim 9, wherein Al crystal grains in a central region of the brazing layer have a diameter of 6 μm or more and less than 60 μm, and
wherein Al crystal grains in a boundary region of the brazing layer with the first aluminum layer of the upper plate or the second aluminum layer of the lower plate have a diameter of greater than 0.0 μm and less than 6 μm.
